(19) United States
(12) Patent Application Publication
(10) Pub. No.: US 2026/0037824 A1
(43) Pub. Date: Feb. 5, 2026

(54) TRANSFER LEARNING IN DIGITAL TWINS

(71) Applicant: Telefonaktiebolaget LM Ericsson (publ), Stockholm (SE)

(72) Inventors: Konstantinos Vandikas, Solna (SE); Abdulrahman Alabbasi, Kista (SE); Ajay Kattepur, Bangalore (IN); Athanasios Karapantelakis, Solna (SE)

(21) Appl. No.: 18/998,218

(22) PCT Filed: Jun. 30, 2023
(86) PCT No.: PCT/SE2023/050681

§ 371 Date: Jan. 24, 2025

(30) Foreign Application Priority Data
Jul. 26, 2022 (GR) 20220100598

(51) Int. Cl. G06N 3/096; G06N 3/045; G06N 3/092

(52) U.S. Cl. CPC G06N 3/096; G06N 3/045; G06N 3/092

(57) ABSTRACT

Systems and methods are described for the transfer learning for digital twins. Embodiments can include a variety of machine learning, reinforcement learning, transfer learning, and other embodiments. Training digital twins of physical objects can run into the problem of limited access to data transfers. In embodiments under the present disclosure a first training can be performed to determine a source domain or transfer learning method that is best, given a certain state or other metadata of a digital twin. Further training can utilize source domains that previously performed best given state and/or metadata and digital twin type.

### TECHNICAL FIELD

The present disclosure generally relates to transfer learning of a machine learning model.

### BACKGROUND

A digital twin is defined as a virtual double of a physical object, system or process. Implementation-wise a digital twin can either be a virtual software module that interfaces with the physical object it represents or a machine learning model that is designed to mimic the behavior of a physical object mapping the input from the environment to a set of effects or actions in a data-driven manner. In the latter case, such a construct is typically trained using real data or via simulation to mimic its physical counterpart. The importance of digital twins is growing since they enable companies to project their workflow onto a virtual space where they can experiment and derive efficiencies much faster than in the physical world. Some applications of digital twins include condition-based maintenance (perform repairs when certain conditions are met), predictive maintenance (anticipate faults and roll out repairs ahead of time) and tracking and monitoring of high-value, perishable goods to reduce loss and damage.

One problem when building digital twins is the amount of data transfer needed for training a machine learning model. Interactive digital twins, for example, can consume large volumes of data. One approach to this problem is to use a simulator. However, simulators are often imperfect representations of the real environment and digital twins trained with a simulator can struggle when exposed to real data not seen during simulation.

Another solution is to use transfer learning (TL). This technique utilizes the re-use of a previously trained machine learning (ML) model that is retrained with data from the digital twin's environment. One challenge with TL is that different TL techniques can consume different volumes of data and yield different levels of quality of the model that's produced.

Another alternative is to rely on edge-computing. Here, the training of each digital twin can take place in the physical asset (if the asset has sufficient computational power). However, this is not the case for every device since not all devices are designed for that or can spare the computational capacity.

### SUMMARY

Embodiments under the present disclosure can solve many of the challenges and problems seen in the prior art. Embodiments include mechanisms, systems, and methods for selecting between various transfer learning techniques that are available for the training of digital twins and, over time, learn the most optimal selection. Data transfer and its associated costs are at a premium in the training of digital twins. It is therefore difficult to provide transfer learning (TL) of digital twins while minimizing data costs. Embodiments under the present disclosure can solve these problems several ways. One way is by reusing previous experiences (or target domains) that have already been collected from the same environment. Furthermore, target domains can be reused across different, yet similar, digital twins.

One embodiment under the present disclosure comprises a computer-implemented method performed by a computing device for training a digital twin. The method includes selecting which of one or more digital twins to train; training the selected one or more digital twins with one or more TL approaches; and determining a state of the one or more digital twins. The method also comprises obtaining metadata associated with the state; obtaining a subset of the one or more TL approaches based on the obtained metadata; selecting one of the subsets of one or more TL approaches with the highest reward for the determined state; transferring the selected TL approach to the one or more digital twins at the determined state; and retraining the one or more digital twins with the selected TL approach.

Another embodiment can comprise a method performed by a network node for training a digital twin. The method comprises determining a state of one or more digital twins; obtaining metadata associated with the state; and obtaining one or more source domains based on the metadata. It also includes selecting one of the one or more source domains with the highest predetermined reward for the determined state; and training the one or more digital twins with the selected source domain.

A further embodiment under the present disclosure comprises a computer-implemented method for configuring a network comprising a plurality of computing devices configured to train digital twins. The method includes obtaining, by a computing device of the plurality of computing devices, a machine learning model. It further includes determining, by the computing device, an update matrix by training the machine learning model based at least in part on a state of one or more digital twin, metadata associated with the state, one or more source domains associated with the metadata, and predetermined rewards for the one or more source domains at a plurality of states and associated metadata, wherein the update matrix comprises the one or more source domains with the highest reward for a determined state. It also includes sending, by the computing device, the update matrix to a network node for configuring the network.

An additional embodiment under the present disclosure comprises a method performed by a computing device for training a digital twin. The method includes receiving a metadata descriptor of a digital twin, one or more source domains, and a first state of the digital twin from a network node; selecting one of the one or more source domains based on the metadata descriptor, the first state, and a policy; and transmitting the selected source domain to the network node for use in training the digital twin. The method further includes receiving from the network node a first reward resulting from the training; receiving from the network node a second state of the digital twin; calculating a second reward of the selected source domain based at least in part on the first reward; and storing the second reward, the first state, and the second state.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows a schematic representation of reinforcement learning;

FIG. 2 shows a schematic representation of an embodiment of the present disclosure;

FIGS. 3A-3B show a schematic of a process flow embodiment under the present disclosure;

FIGS. 4A-4B show a schematic of a process flow embodiment under the present disclosure;

FIG. 5 shows a flowchart of a method embodiment of the present disclosure;

FIG. 6 shows a flowchart of a method embodiment of the present disclosure;

FIG. 7 shows a flowchart of a method embodiment of the present disclosure;

FIG. 8 shows a flowchart of a method embodiment of the present disclosure;

FIG. 9 shows a schematic of a system embodiment under the present disclosure;

FIG. 10 shows a schematic of a user equipment (UE) embodiment under the present disclosure;

FIG. 11 shows a schematic of a network node embodiment under the present disclosure;

FIG. 12 shows a schematic of a host embodiment under the present disclosure;

FIG. 13 shows a schematic of a virtualization environment embodiment under the present disclosure;

FIG. 14 shows a schematic representation of an embodiment of communication amongst nodes, hosts, and user equipment under the present disclosure; and

FIG. 15 shows a schematic block diagram of a computing device according to embodiments of the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

As discussed above, a digital twin is a virtual double of a physical object, system, or process. A digital twin can be a virtual software module that interfaces with the physical object it represents, or a machine learning (ML) model that is designed to mimic the behavior of the physical object. In some relevant examples, a physical object or asset can comprise various types of radio equipment deployed in the field: network nodes, transmitters, receivers, user equipment (UE), and more. Each piece of equipment can come from different vendors and can have very different characteristics in power consumption, performance, bandwidth, efficiency, and more. Multiples instances of the same equipment may be implemented in different environments: location, temperature, altitude, and more can all vary based on location. Assuming a physical asset is equipped with a module that allows it to transmit different information in a wired/wireless network—the main challenge when building a digital twin is the amount of data that is required for training its underlying machine learning model. Since digital twins are meant to be interactive—they are typically built using machine learning techniques that use large volumes of data to model different aspects of the digital twin using one or a combination of machine learning (ML) models. One way to deal with this problem (volume of data) is to use a simulator. However, simulators are typically limited to their own representation of the environment which might not approximate the real environment close enough and miss important details.

One example from a radio equipment perspective is that in real life there are multiple types of radio equipment deployed in the field, in most cases from different vendors and each equipment has very different characteristics when it comes to how much power it outputs and how much energy it consumes based on its configuration. Simulators are not designed to capture these aspects and as such, simulated models fail in real life. To compensate for this, digital twins trained in simulation then graduate from the simulator to use real data, but this has problems since the agents trained over simulation would then underperform when they encounter real data not seen during the simulation phase.

In the state of the art the known method to address this challenge is to use transfer learning (TL) which effectively allows the re-use of a previously trained ML model which can then be re-trained using additional data coming from the digital twin's environment. The main challenge when applying this technique is that there are several different types of TL techniques that can be applied that have a different impact on the volume of data that is needed from the network and a different effect on the quality of the model that is produced. One example is reinforcement learning (RL). RL is a type of ML that utilizes the rewarding of desired behavior and punishing undesired behaviors. A RL agent can typically interact with its environment and take actions and learn through a process of trial and error.

One solution uses a mechanism that automatically composes ML model ensembles by associating the input/output of individual ML models towards a specific output. However, that work is limited to ML model chaining of pretrained models and does not address the case of reinforcement learning where a model requires input from its environment which could either be related to the state space, the action space, the reward function, the value function, the policy or any combination thereof. Aspects of ML model chaining were described in WO 2021/239201 A1, titled “Transfer Learning of Machine Learning Model in Distributed Network.”

Another alternative for solving this problem is to rely on edge-computing where essentially the training of each digital twin takes place in the physical asset itself assuming that the asset has spare computational capacity. However, this is not the case for every device since not all devices are designed for that or can spare the computational capacity.

This disclosure proposes mechanisms for selecting between the different transfer learning techniques that are available for digital twins and over time learning the most optimal selection.

The TL repository can comprise a facility that stores a mapping between a signature for many or every digital twin and the set of possible transfer learning target domains which have or can be collected. The selection mechanism which determines which TL target domain to choose given the similarity of the source digital twin and the available signatures in the TL repository can comprise a reward function that governs how to choose accordingly the source domain (action) that yields the highest reward (in other words the lowest transfer of data).

An advantage provided by some of the embodiments under the current disclosure is an efficient method to train a digital twin by reusing previous experiences (target domains) as they have been collected from the same environment without the need of costly data transfer for the original physical asset. Proposed disclosure takes advantage of the fact that in a manufacturing space (and other environments) there can be a plethora of similar physical assets—therefore to avoid transferring information from all them we categorize and rely on transfer learning techniques to minimize the cost of training their digital twin versions.

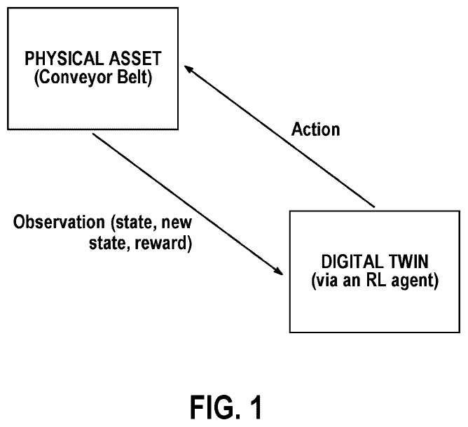

The process of using RL to train a digital twin is shown in FIG. 1. A physical asset has a digital twin that is supposed to represent the physical asset in at least some way. As observations (e.g., state, new state, reward) is sent to the digital twin via an RL agent, actions are reported to the physical asset.

Moreover, we can describe an RL problem as M=(μ₀, S, A, γ, R) where:
μ₀: initial states
S: state space
A: action space
R: reward function—R(s,a,s′) specifically is the reward that an agent s receives if it performs action a on state s thus leading to the new state s′.
γ: discount factor

Given these preliminaries the problem of TL is formulated as how can we learn an optimal policy (π*) for a target domain M_{T} using external information from one or more source domains M_{S}. Target and source domains comprise TL approaches or methods that can be used to train e.g., a digital twin. Source domain generally refers to TL approaches stored previously, such as in the TL repository, described herein. Target domain generally refers to TL approaches applied to a digital twin. Some approaches include:
Reward shaping (use an external function to further enhance the reward function used in the reinforcement learning loop). The reward function has many components including:
   a. Weighting function describing which module in the digital twin has more value, e.g., in a reward function with multiple elements of the reward (for example the goal of the reward function is to maximize throughput and reduce latency) then a weighing function might say that throughput is more important the latency.;
   b. Impact of TL approach or source domain on radio environment (reliability, latency, key performance indicator (KPI), etc.); and
   c. Impact of transferring the selected TL scheme on radio environment (e.g., Bandwidth, interference, etc.);
Learn from demonstrations which draws similarities from imitation learning—the input in this case is a list of observations performed either by an expert or another twin which are then used as input to the RL model.
Value function transfer or shaping: this value function is used to guide the policy, hence when transferred from one agent to another, we could use different (e.g., weighted) or similar approaches to guide the output.
Policy transfer where the policy function is transferred between agents either by doing:
   a. Knowledge distillation (KD);
   b. Policy re-use;
   c. Inter-task mapping where the source domain is mapped to the target domain [Note: representation transfer has been omitted since that is similar to inter-task mapping with the exception of using multiple mapping functions for each aspect of the domain]; or
   d. Quantization of data (used to train or to replace existing models as KD) transferred to DT. Here the “data” could be TL data or other AI-information.

One proposed system embodiment under the present disclosure for solving the described challenges comprises two nodes: a TL proxy agent and a TL repository. Possible system embodiment environments include radio or telecommunication networks. The TL proxy agent and TL repository could comprise nodes in a network, such as base stations. Either component could be implemented in base stations, servers, UEs or other network components. Other embodiments could comprise part of any system for modeling an environment or system.

The TL proxy agent can run an agent (e.g., software module, computing device, and/or comprising hardware or software) that learns which type of transfer learning to perform given a digital twin as input along with the digital twin's state space. The TL proxy agent conduct the following tasks:
Take actions given the digital twin's state. The action is the choice of a TL approach. TL approaches/types/methods are contained in the TL repository and can comprise the TL algorithm, function and/or reward function used as the source or target domains;
Request and receive states of Digital Twin, DT, that describes its environment, could be for example a detection of system or data drift of the DT; and
Conduct quantization or AI-information processing before sending data to DT or requesting from TL repository.

The TL repository contains several different functions/data for the aforementioned TL approaches, some of which are grouped into the categories below:
Reward Functions: Reward shaping functions for different types of DTs. This data includes functions that indicate the reward distribution of the target domain and help guide the training of the agent—i.e., choosing a better action for a given state than a random action in the initial stages of training/exploration.
Demonstration Data: Demonstrations from other DTs. This data helps accelerate training of the target DT by means of demonstration data, already used to trained an agent for another DT.
Policies Data: Policies from other DTs. This data is pretrained models from other DTs (e.g., in the form of pretrained weights for layered neurons in deep RL), that are transferred to the target DT prior to training and help accelerate the training process. The transfer can happen in the form of single copying of weights from the source DT model to the target DT model, or a many-to-one technique can be used such as those in ensemble learning.
Mapping Functions: Predefined Inter-Task mappings between the target M_{T} domain and the source M_{S} domain. Such an approach could allow the agent preferring actions over others by mapping them to actions on a domain that another agent has already been trained on.

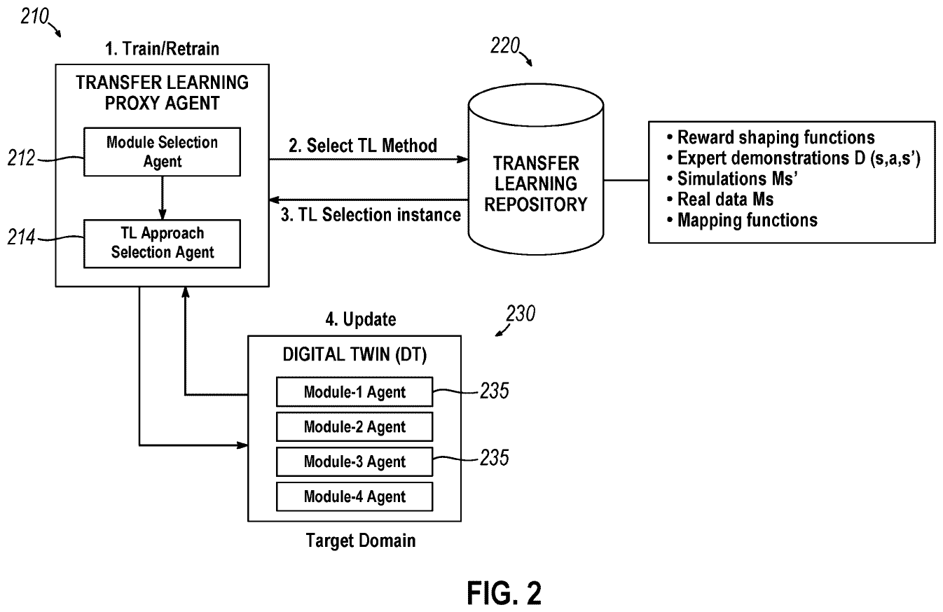

Certain functionality of the TL proxy agent and TL repository, such as described above, is illustrated in FIG. 2. TL system 200 comprises a digital twin 230, TL proxy agent 210, and TL repository 220. In this example, we consider that the DT 230 consists of several module-agents 235 (each one has different ML model, KPIs, actions, etc.). Hence, each of those module-agents 235 could drift and require some updates. ‘Drift’ refers to situations where the input used to train a module no longer correlates with the target variable. Here, for example, the input (e.g., state, action) might no longer correlate with the Q-value. Hence, the TL proxy agent 210 can proceed with executing:
Module selection agent 212 (Agent-Mod), that decides on which module requires TL. For instance, such module could be, e.g., Quick UDP Internet Connections (QUIC) protocol characteristics, Radio Resource Control (RRC) configuration AI/ML agent, Media access control (MAC) traffic scheduler AI/ML agent, etc.
TL approach selection agent 214 (Agent-TL), which select among modules from the sources, Export, Simulator, and user equipment (UE) Physical twin.

Due to the nature of the problem, both Agent-Mod 212 and Agent-TL 214 can be interacting during their training and execution phases. In the following, certain functionalities are described that can be extensions of the previous description (i.e., complementing to previous section, preferably not considered alone). The description below focuses on rewards and actions.
Rewards: both Agent-Mod 212 and Agent-TL 214 preferably consider the following combination function of rewards:
   a. Weighting function describing which module-agent 235 in the DT 230 has more value, e.g., for modules that are application traffic module, or RAN leg module, etc.
   b. Impact of TL approach or source domain on radio environment (reliability, latency, KPI, etc.)
   c. Impact of transferring the selected TL scheme on radio environment (e.g., bandwidth, interference, etc.)
Action: both Agent-Mod 212 and Agent-TL 214 preferably consider the following actions vector:
   a. Primary Agent's Action—decision on which TL approach (also referred to as source domain) is to be used.
   b. Extended Agents' Action:
      i. Decision on characteristics of knowledge distillation (KD);
      ii. Decision on which digital module agent 235 (or its constituent components) will be targeted for the TL (can be included in above action, but not necessarily);
      iii. Decision on Radio methods (e.g., quantization levels) of transmitting such TL;
      iv. Decision on changing KPI of the agent of the module-agent 235 (or its constituent components) in DT 230;

A possible order of operations is shown in FIG. 2. At 1, TL proxy agent 210 receives a request or notification to train one or more module-agents 235 in DT 230. At 2, a TL method is selected or obtained from the TL repository 220. At 3, the specific selected TL instance is received by the TL proxy agent 210. At 4, the DT 230 is updated with the selected TL instance.

Possible real-world embodiments of the described systems include the training of Radio Units, Switches, Antenna, or baseband with similar characteristics. For example, there are multiple radios deployed but they all consume very similar energy for a given physical resource block (PRB) utilization. As such the proposed TL repository which contains the corresponding source domains that can be used for transfer learning purposes during the process of training a digital twin of a Radio will be finite and the search would be tractable due to the use of cosine similarity.

Disclosed embodiments can scale to an arbitrary number of agents (targets) and source domains since the TL repository is bounded by classes of agents and not specific instances. In addition, the training can be bounded to focus on one module-agent at a time thus limiting the number of resources needed while training a module-agent using the proposed approach. In addition, when it comes to compound agents (module-agents that consist of other module-agents and so on) the system can train them hierarchically starting from the top module-agent (most general) and then proceeding to the bottom (least-general agent) thus benefiting from the previous generalized trainings to simplify the training of the simpler module-agents.

Categorization and similarity is further explained below, but one example is given here using radio equipment. If we take a specific example when it comes to radio equipment, we expect that each equipment is characterized by certain properties such as the following (provided here as an example without loss of generality):
ProductNumber;
ProductCategory e.g., RF;
Physical Properties (such as Weight, WeightUnit, Length, Width, Height); and
RState (revision).

Such information can be used to distinguish radio product instances to specific classes of products and therefore enable categorization to facilitate the similarity selection process.

The state of the system is captured in each source domain M=(μ₀, S, A, γ, R), therefore a selection process can be driven from that. The TL repository is designed to match the similarity of DTs (or their constituent components including module-agents) to such source domains or TL approaches, and we assume that similar agents (e.g., radios) will match to similar source domains and therefore be assigned the expected source domain that matches their state during this process.

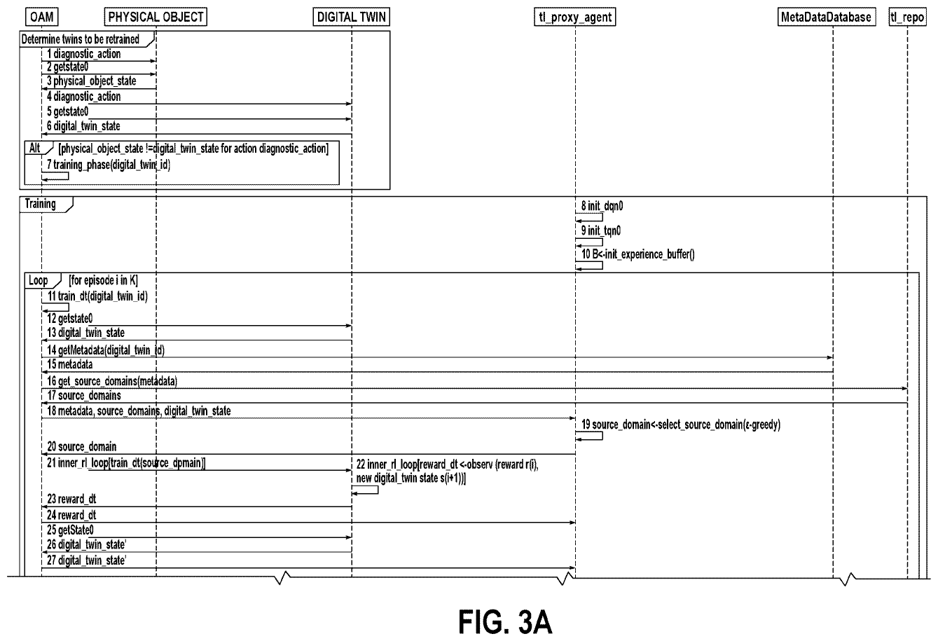

FIGS. 3A-3B show one possible sequence diagram for training a TL proxy agent. In this embodiment, the process can be broken up into three general phases in the process of maintaining the lifecycle of the TL proxy agent: determining what to update, training, and the operational phase. This embodiment comprises an Operation and Management (OAM) node (such as in a telecommunications network), a physical object, a digital twin, a TL proxy agent, a metadata database, and a TL repository. While the process flow shown in FIGS. 3A-3B comprise these components, other implementations can comprise additional components. The disclosed components help serve to illustrate the functionality of the described embodiment but should not be seen as limiting as to what components can perform each step of the process shown.

The first phase (steps 1-7 of FIG. 3) aims at determining which digital twins need to be updated. This is done by performing a diagnostic action to a DT(s) (steps 4-6) and the physical object (steps 1-3) the DT is mimicking and then comparing their state (step 7). Ideally their state should be similar otherwise the DT is out of sync with the physical object and as such needs to be retrained. The outcome of this process (steps 1-7) can be one or more DT identifiers which can be used later on either in the training phase where the TL proxy agent is updated or in the operational phase where the TL proxy agent is no longer updated but instead the system/method relies on the previously trained version of the TL proxy agent. DT identifiers could comprise a vector where every element of the vectors describes some dimensions of the DT. For example, the type of DT (1 for Radio Unit, 2 for Radio Dot, 3 for WiFi access point, etc.). Vectors are useful as identifiers because they can be compared. It is preferable that any identifier used comprise a function that makes it comparable, or that measures some type of distance.

The second phase is the training phase which captures steps 8 to 32 of FIG. 3. This phase comprises two RL loops, the outer loop is what is described from steps 8 to 32 while the inner loop is discussed at steps 21-22. Steps 8,9 and 10 are preparatory steps that initialize the DQN, TQN and experience buffer for the TL proxy agent. The steps shown here for 8, 9, and 10 represent an implementation of deep RL, which may not be applicable in other RL embodiments.

Steps 11-33 take place in a loop for a series of episodes and for a given DT. Step 11 triggers the process of a given digital_twin identifier. Step 12 is to retrieve the state of the DT from the DT. At step 13 the digital twin sends its state back to the OAM node. At step 14, the OAM node uses the metadata database (which can comprise any type of storage device or server) to find a more general description for the DT which will be used afterward with the TL repository to identify potential source domains for that object. At 15 the general description of the DT is received from the metadata database. At 16, the OAM node requests possible source domains from the TL repository for the given metadata description of the DT. At 17, the TL repository provides the potential source domains to the OAM node. At step 18, the metadata, source domain (TL approach) and digital twin state are sent to the TL proxy agent which will use those as input to determine its action for the given general description of the digital twin. At step 19, because this is a training process policy will be used to select a source domain. One such policy would be an ε-greedy policy. At step 20 the source domain selection is sent to the OAM node. At 21, the OAM uses this source domain in the inner RL loop to (re)train the DT. At 22, the reward of the inner loop for the DT is recorded by the DT. At step 23, the reward produced by the inner RL loop for training the DT is sent to the OAM node since it will be used later by the TL proxy agent to verify the high reward (on average) of the source domain selection for the training of the DT. In a different embodiment a supervised learning approach could be used instead of an RL loop. In such embodiments we could use as a reward the output of a loss function instead. At step 24, the reward of the DT (or the value of the loss function) is sent to the TL proxy agent. At 25, the OAM requests the new state of the DT now that it has been retrained. At 26 the new state of the DT (digital_twin_state') is sent to the OAM node. At step 27, the OAM node sends the digital_twin_state' to the TL proxy agent. At step 28, the TL proxy agent calculates its own reward which is a function of the reward of the DT. At step 29, the reward, previous state of the DT, and new state of the DT are recorded in the experience buffer of the TL proxy agent. At step 30, at every Y iterations (this could be determined by a user), a random set of mini batches from the experience is collected to train the RL agent's DQN (deep Q network) minimizing the loss between the expected reward for a given state and an action using discount γ (step 14 defines a possible loss function). At 31, a loss function is defined combining DQN and TQN (target Q network). At 32, training of the DQN is performed to minimize the distance between current optimal Q value and the historical Q value as captured by the TQN. At 33, after every M iterations (M>Y), the TQN is updated by the DQN. As an example of a reward function for this problem, the reward of the transfer learning can be considered to be equal to the reward of the DT that has been trained with the selected source domain discounted by the volume of data that has been transferred when copying the source domain from the TL repository to the OAM node. This could be illustrated with the equation:

$${R}_{TL} = {R}_{Dt} - TC ( {M}_{s} )$$

The third phase is the operation phase and is shown with steps 34 to 44 in this embodiment. Steps 34 to 44 are similar to steps 11 to 21—the main difference is that the RL loop is now shorter and no feedback is collected since we rely on the capability of the function trained previously to be able to select the proper source domain to use as a basis for training a DT. At step 34, the process is triggered for a given digital_twin identifier. Step 35 is to retrieve the state of the DT from the DT. At step 36 the digital twin sends its state back to the OAM node. At step 37, the OAM node uses the metadata database to find a more general description for the DT which will be used afterward with the TL repository to identify potential source domains for that object. At 38 the general description of the DT is received from the metadata database. At 39, the OAM node requests possible source domains from the TL repository for the given metadata description of the DT. At 40, the TL repository provides the potential source domains to the OAM node. At step 41, the metadata, source domain (TL approach) and digital twin state are sent to the TL proxy agent which will use those as input to determine its action for the given general description of the digital twin. The TL proxy agent, at step 42, can choose which source domain to use based on what source domain has previously had the highest/best reward for a given metadata and/or state. At 43, the TL proxy agent sends the source domain selection to the OAM node. At 44, the OAM trains the DT with the selected source domain (or TL approach).

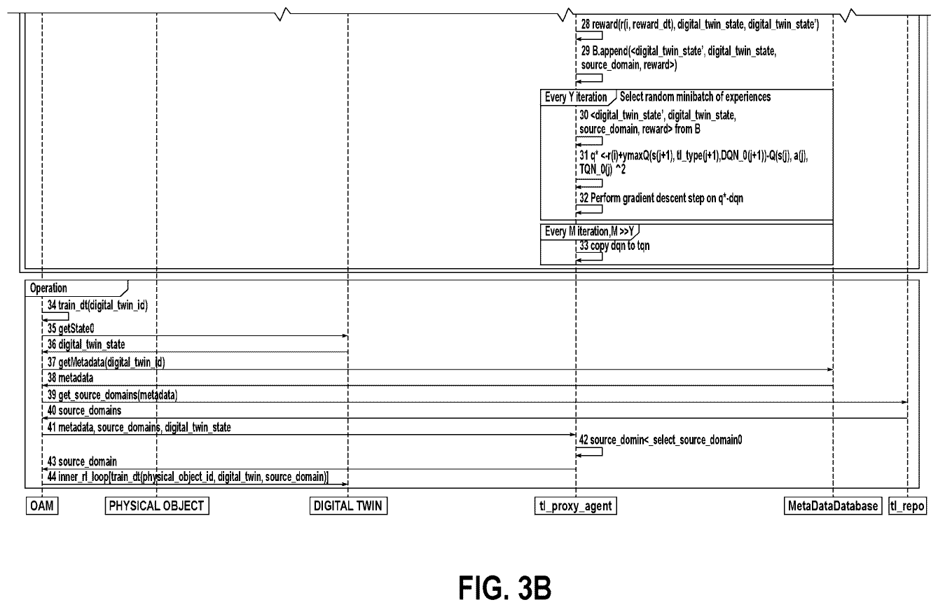

Another possible sequence diagram of an embodiment under the present disclosure is shown in FIGS. 4A-4B. This embodiment shows an OAM node (such as in a telecommunications network), a DT, a TL proxy agent, and a TL repository. FIGS. 4A-4B show a possible sequence diagram embodiment for training a TL proxy agent. FIGS. 4A-4B focus on two phases: a training phase and an execution phase. In the training phase the TL proxy agent tries different transfer learning techniques (TL method or source domain) for the given DT and rewards itself based on how well the DT performs once it has been trained with the given source domain (based on the DT's reward function)—the DT's reward function is re-used by the TL proxy agent's reward function. In the execution phase the TL proxy agent is limited to exploration—re-using the Deep Q Network (DQN) that was trained in the previous phase.

At step 1, the DQN network of the TL proxy agent is initialized either with random weights or with a pretrained model if one is available. At step 2, the TQN network is initialized, which will be used later to handle the non-stationarity of the target values. At step 3, the experience buffer is initialized which will collect samples—TL choices, previous states, next state and rewards to train the TL proxy agent. Steps 1-3 are performed by the TL proxy agent.

At step 4 the training loop begins. At step 4, an OAM (e.g., in a 3GPP network) submits a request to train a new DT of type T. Instead of directly collecting data for the twin to be trained, the TL proxy agent can be relied on, which will identify information from the TL repository to re-use and perform model transfer to avoid the costly process of collecting real data. At steps 5-6 state and/or metadata information are requested and received from the DT. At 7, the state and/or metadata from the DT is copied from the OAM node to the TL proxy agent. At 8, the OAM requests from the TL repository those how well the DT performs once it has been trained with the given source domain (based on the DT's reward function)—the DT's reward function is re-used by the TL proxy agent's reward function. In the execution phase the TL proxy agent is limited to exploration—re-using the Deep Q Network (DQN) that was trained in the previous phase.

At step 1, the DQN network of the TL proxy agent is initialized either with random weights or with a pretrained model if one is available. At step 2, the TQN network is initialized, which will be used later to handle the non-stationarity of the target values. At step 3, the experience buffer is initialized which will collect samples—TL choices, previous states, next state and rewards to train the TL proxy agent. Steps 1-3 are performed by the TL proxy agent.

At step 4 the training loop begins. At step 4, an OAM (e.g., in a 3GPP network) submits a request to train a new DT of type T. Instead of directly collecting data for the twin to be trained, the TL proxy agent can be relied on, which will identify information from the TL repository to re-use and perform model transfer to avoid the costly process of collecting real data. At steps 5-6 state and/or metadata information are requested and received from the DT. At 7, the state and/or metadata from the DT is copied from the OAM node to the TL proxy agent. At 8, the OAM requests from the TL repository those DTs that match or are similar to the DT being trained. Since the TL repository has information for multiple DTs—but the TL repository preferably limits its search to those DTs that match the DT being trained. At step 9, a list of relevant DTs based on some similarity function (e.g., cosine similarity) is returned to the OAM node. At 10, the TL proxy agent selects a TL approach to use for training. As part of the exploration phase, an epsilon greedy policy (selects any action a with probability ε or the action that maximizes Q value with probability 1-ε) is preferably used to determine which TL to choose. Other policies are possible, however. In the scope of this problem our action space can be to:
learn from demonstrations (D);
learn from an already existing source domain Ms;
learn from a demonstrated source domain Ms′;
learn from domain adaptation;
learn from another reward function R (e.g., five discrete actions); or
rely on a set of mapping functions which can be used to map (convert) one source domain Ms to the target domain M_{T}. A mapping function can also comprise a learning distance function.

At step 11, TL type is communicated back to the OAM node. At step 12, depending on this choice, the OAM node will perform the selected action by seeking the required TL type in the TL repository for the given set of relevant DTs. At step 13, the source domain related to the TL type is sent back to the OAM (in certain embodiments this can be the only data transfer that happens during the process). At 14, the OAM node trains the DT using the selected TL type/source domain. At 15, the OAM node tests the DT that was trained using the source domain using the reward function that has been provided by the source domain and depending on that score calculates the reward. At step 16, the reward, previous state and next state of the TL type is recorded in the experience buffer. At 17, the TL type collected in Step 11 is, and the reward, previous state, and next state, are copied to the experience buffer B by the TL proxy agent.

Every Y iterations, at step 18, a random set of mini batches is collected from the experience to train the RL agent's DQN, minimizing the loss between the expected reward for a given state and an action using discount γ. At step 19, a loss function is defined that combines DQN and TQN. The loss function may have been provided in step 14 and can be used here. At step 20, training of the DQN model is performed so as to minimize the distance between current optimal Q value and the historical Q value as captured by the TQN. Every M iterations (where M>Y), and at step 21, the TQN is updated by the DQN.

Steps 22-31 illustrate the execution phase. Steps 22 to 31 are similar to steps 4 to 14 with the exception that the TL proxy agent is not trained again, instead the previously trained model is exploited. At step 22, the process is begun by the OAM requesting to train a DT. At steps 23 and 24, the OAM requests and receives state and/or metadata from the DT. At 25, this state and/or metadata is transmitted to the TL proxy agent. At 26 and 27, the OAM requests and receives similar DTs to the DT being trained. At 28 and 29, the TL proxy agent selects a TL type and sends it to the OAM. At 30, the OAM transmits a TL type identification based on the similar DTs. At 31, based on the TL type for the similar DTs, the TL repository sends the OAM a related source domain to use for training. The OAM, at 32, then proceeds to train the DT(s) with the selected source domain.

### Filtering TL Methods

When considering large-scale deployments of certain disclosed embodiments, there may be an increased complexity because there could exist:
multiple types of DTs (for example, in addition to the radio unit example, including other radio base station components such as switches, routers, fan control units, battery control units, power supply and distribution units, basebands, etc.); and
complex types of DTs, i.e., DTs consisting of multiple smaller DTs that can be of different types. An example is a “Radio Base Station” DT which comprises multiple possible DTs mentioned above and more.

Therefore, while selecting a TL method (e.g., TL type, source domain, TL approach) from the repository, an agent not only risks action space explosion (as the number of DTs would increase over time) but also choosing a DT that is irrelevant to the target domain (for example, choosing a reward function for a fan control unit, while the target domain is a radio unit). Another issue is the intractability of training process, as the action space would be ever growing or shrinking, as new types of DTs are added and/or removed. Regardless of whether deep learning is used or not, that has an impact on the internal data structure used for policy selection (e.g., expanded, or retracted Q-table or change of output layer in deep neural networks, etc.). Presented below are several possible embodiments for dealing with the relevancy problem and the intractability problem.

Considering the relevancy problem, metadata can be used to describe the “type” of DT in terms of
functional purpose, e.g., some formalization of “baseband”, “AC to DC power supply”, “Power Distribution”, “radio unit”, etc.; or.
configuration, e.g., software revision (e.g., “CV 3.2a”), manufacturer (e.g., “Ericsson™”), model (e.g., 5512, 6630 in case of baseband, 4402, 4460 in case of radio unit), but also functional purpose-specific information such as frequency served in every port (e.g., 2.400-2.420 MHz), port property (rx/tx/both) in case of “radio unit” functional purpose. In another example where functional purpose is baseband, active CPRI ports (port IDs) and port configuration (what frequency range each port transceivers) can be provided.

In another embodiment, if detailed metadata does not exist, then the type could be based on a quantification of the different input and output interfaces of the DT (in terms of number and maybe format of each constituent—e.g., int16, int32, float64, boolean, etc.). For both embodiments above, the type could be done in cascading fashion, aggregating information for all inner DTs a DT may comprise of as well. When a new DT for a target domain is planned to be created and prior to transfer learning process commencing, a similarity search between the “type” (as defined above) of the target domain DT and the type of those DTs that TF methods are based on and exist in the database are compared using some similarity comparison method. This similarity comparison method could be based on vectorizing the features of the type, and doing a similarity matching e.g., cosine similarity. If the cosine difference is less (or equal to) a threshold, then the DTs are considered “similar”. Alternatively it could be a rule-based similarity method with hardcoded if . . . then . . . else statements and thresholds. Based on what the above methods evaluate as “similar”, the action space is reduced to the instances of TL methods/source domains/TL type/TL approach supported by the similar DTs in the repository.

Considering the intractability problem, this can be due to non-stationarity of the action space. In this case, there can be potentially “similar” DTs added to the repository after the initial selection of “similar” DTs is conducted and the agent is trained. Therefore, the action space containing TL methods from “similar” DTs could be larger than the trained agent was trained to consider it to be. In such cases, transfer learning could happen in the hidden layers such as the last “dense”/“fully connected” layers and classification layer. Q-tables can also be expanded in terms of dimensions, copying existing Q-table to the new one. The training process of the agent could therefore repeat periodically to make sure that it is up to date with latest updates in the repository

### Additional Embodiments

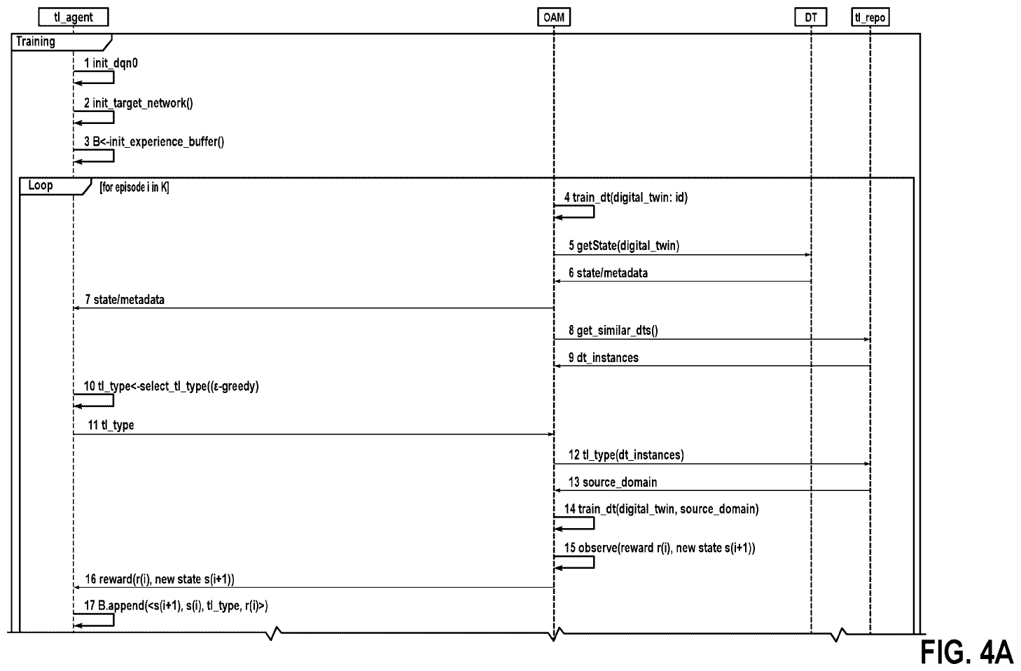

FIG. 5 shows a possible method embodiment under the present disclosure. Method 500 comprises a computer-implemented method performed by a computing device for training a digital twin. Step 510 is selecting which of one or more digital twins to train. Step 520 is training the selected one or more digital twins with one or more TL approaches. Step 530 is determining a state of the one or more digital twins. Step 540 is obtaining metadata associated with the state. Step 550 is obtaining a subset of the one or more TL approaches based on the obtained metadata. Step 560 is selecting one of the subset of one or more TL approaches with the highest reward for the determined state. Step 570 is transferring selected TL approach to the one or more digital twins at the determined state. Step 580 is retraining the one or more digital twins with the selected TL approach.

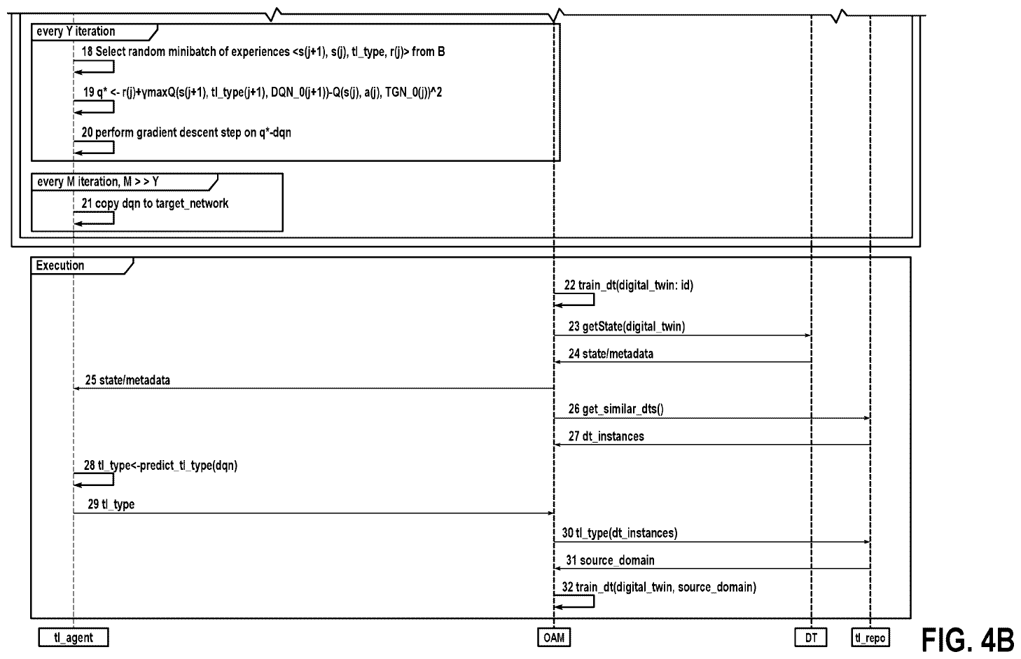

FIG. 6 shows another possible method embodiment under the present disclosure. Method 600 comprises a method performed by a network node for training a digital twin. Step 610 is determining a state of one or more digital twins. Step 620 is obtaining metadata associated with the state. Step 630 is obtaining one or more source domains based on the metadata. Step 640 is selecting one of the one or more source domains with the highest predetermined reward for the determined state. Step 650 is training the one or more digital twins with the selected source domain.

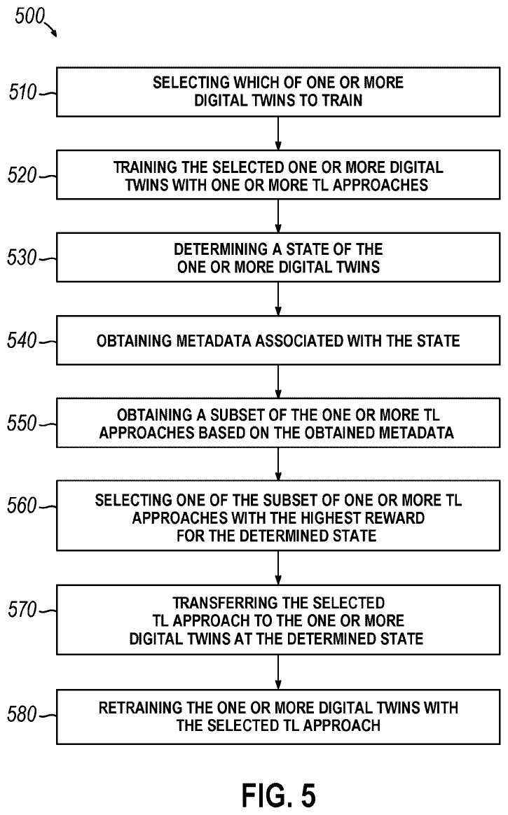

FIG. 7 shows a further possible method embodiment under the present disclosure. Method 700 comprises a computer-implemented method for configuring a network comprising a plurality of computing devices configured to train digital twins. Step 710 is obtaining, by a computing device of the plurality of computing devices, a machine learning model. Step 720 is determining, by the computing device, an update matrix by training the machine learning model based at least in part on a state of one or more digital twin, metadata associated with the state, one or more source domains associated with the metadata, and predetermined rewards for the one or more source domains at a plurality of states and associated metadata, wherein the update matrix comprises the one or more source domains with the highest reward for a determined state. Step 730 is sending, by the computing device, the update matrix to a network node for configuring the network.

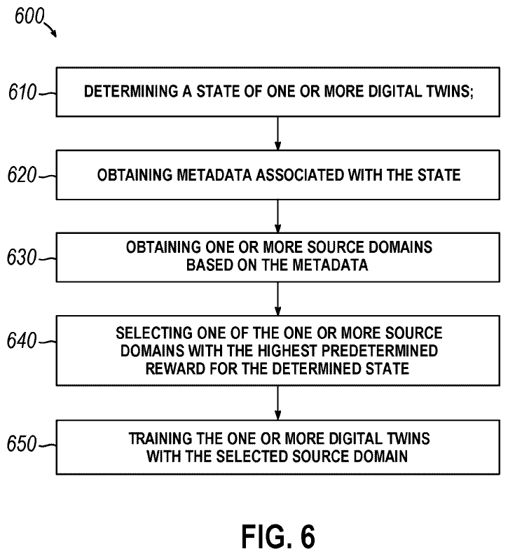

FIG. 8 shows another possible method embodiment under the present disclosure. Method 800 comprises a method performed by a computing device for training a digital twin. Step 810 is receiving a metadata descriptor of a digital twin, one or more source domains, and a first state of the digital twin from a network node. Metadata can include e.g., functional purpose, configuration, manufacturer, model, frequency served, port property, active CPRI ports, port configuration, and more. Step 820 is selecting one of the one or more source domains based on the metadata descriptor, the first state, and a policy. Step 830 is transmitting the selected source domain to the network node for use in training the digital twin. Step 840 is receiving from the network node a first reward resulting from the training. Step 850 is receiving from the network node a second state of the digital twin. Step 860 is calculating a second reward of the selected source domain based at least in part on the first reward. Step 870 is storing the second reward, the first state, and the second state.

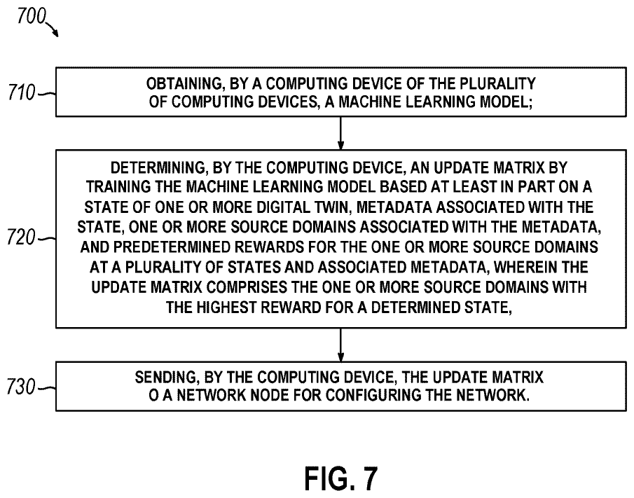

FIG. 9 shows an example of a communication system 1100 in accordance with some embodiments. In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110aand 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections. In relation to e.g., FIGS. 3A-3B and FIGS. 4A-4B, the OAM node can comprise any node 1110a/bwithing system 1100. The TL proxy agent can be implemented across nodes 1110a/b or UEs 1112a/b/c/d. UEs 1112a/b/c/d can comprise DTs and their module agents. The metadata database and TL repository can similarly be implemented across nodes 1110a/b or UEs 1112a/b/c/d. The physical object can comprise one UE 1112a (or a portion thereof) and the DT can comprise a different UE 1112c (or a portion thereof). Nodes 1110a/b can also comprise physical objects or DTs that need training.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

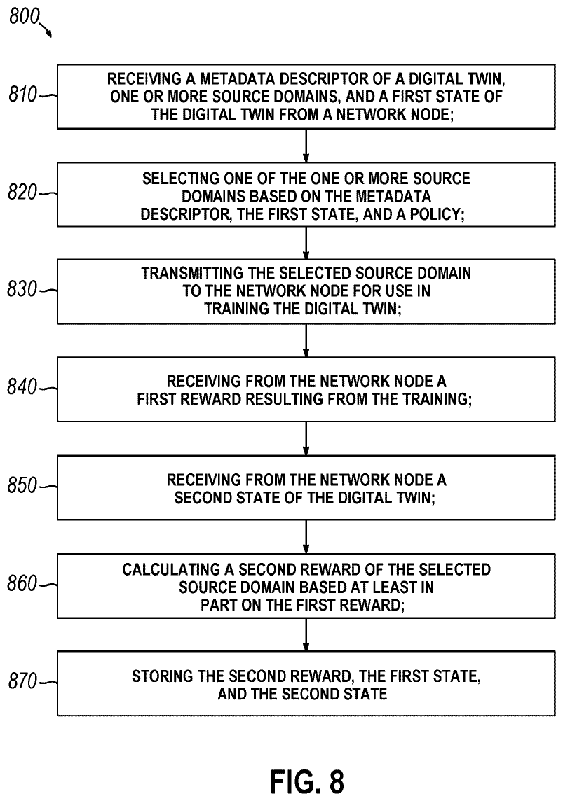

FIG. 10 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

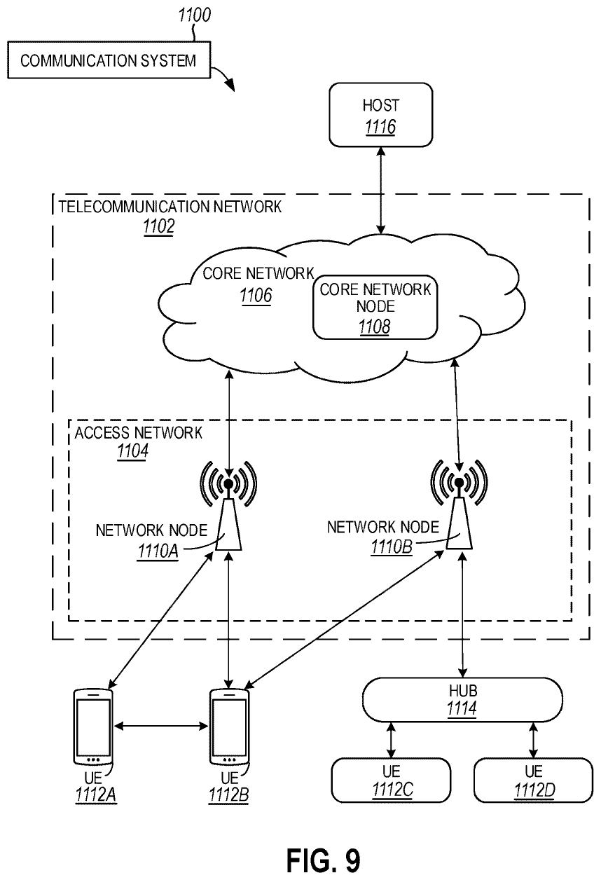

FIG. 11 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 11 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

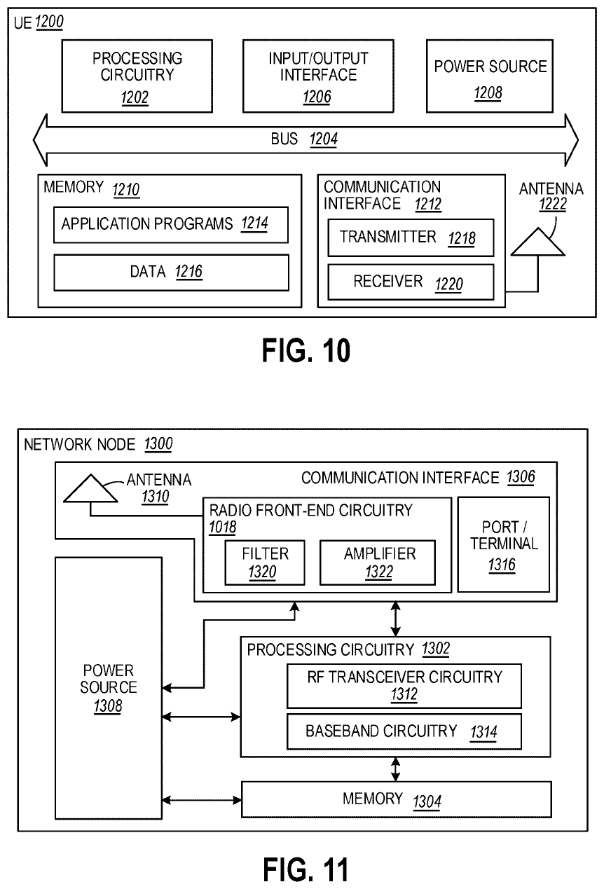

FIG. 12 is a block diagram of a host 1400, which may be an embodiment of the host 1116 of FIG. 9, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 10 and 11, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

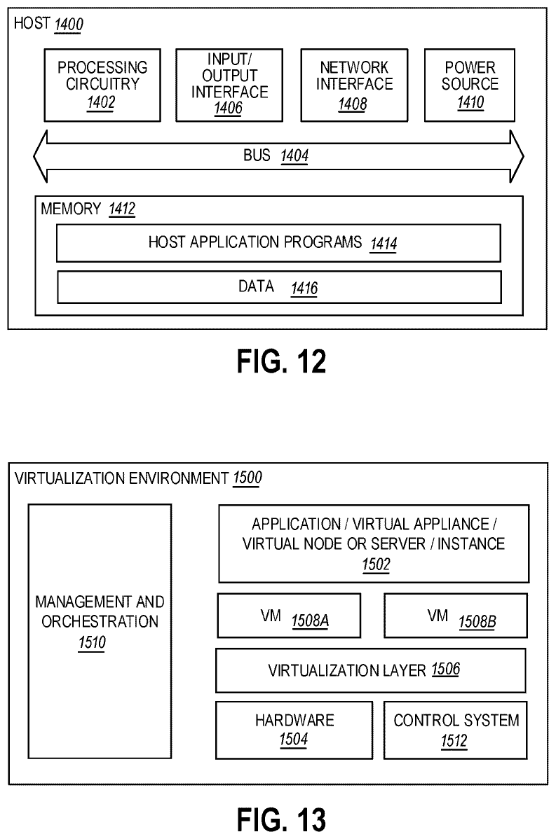

FIG. 13 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

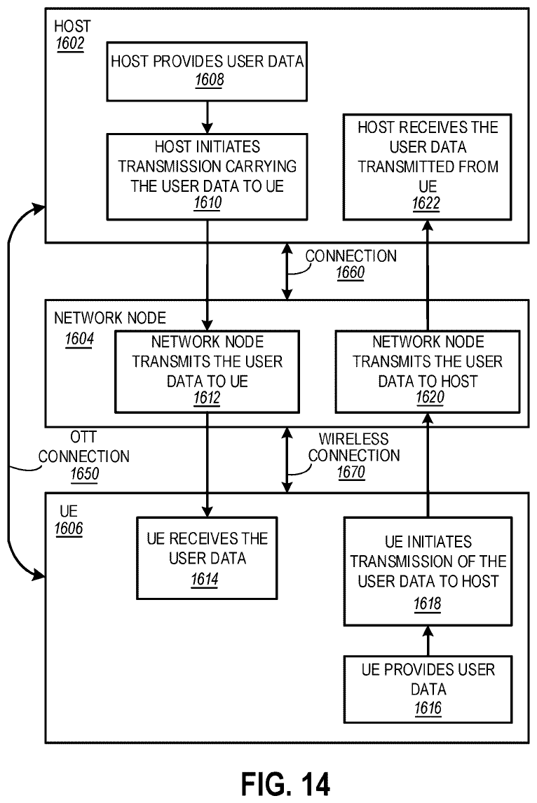

FIG. 14 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 9 and/or UE 1200 of FIG. 10), network node (such as network node 1110a of FIG. 9 and/or network node 1300 of FIG. 11), and host (such as host 1116 of FIG. 9 and/or host 1400 of FIG. 12) discussed in the preceding paragraphs will now be described with reference to FIG. 14.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 9) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

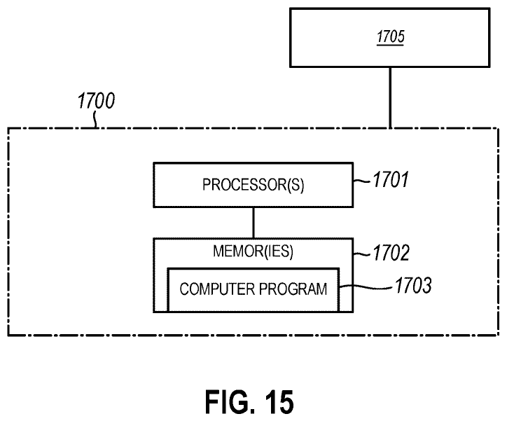

FIG. 15 shows a schematic block diagram of a computing device 1700 according to embodiments of the present disclosure. The computing device 1700 may include at least a processor 1701 and at least a memory 1702. Memory 1702 can have stored there on a computer program 1703 which, when executed on the processor 1701, causes the processor 1701 to carry out any of the methods performed in the OAM node, TL proxy agent, TL repository, metadata database, or other components comprising a computing device according to the present disclosure. The memory 1702 may be, e.g., an Electrically Erasable Programmable Read-Only Memory (EEPROM), a flash memory and a hard drive. The processor 1701 may be a single CPU (Central processing unit) but could also comprise two or more processing units. For example, the processor 1701 may include general purpose microprocessors; instruction set processors and/or related chips sets and/or special purpose microprocessors such as Application Specific Integrated Circuit (ASICs). The processor 1701 may also comprise board memory for caching purposes. The computer program 1703 may be carried by a computer program product connected to the processor 1701. The computer program product may comprise a computer readable medium on which the computer program 1703 is stored. For example, the computer program product may be a flash memory, a Random-access memory (RAM), a Read-Only Memory (ROM), or an EEPROM, and the computer program modules could in alternative embodiments be distributed on different computer program products in the form of memories within the UE or the network nodes. Interface 1705 can comprise a touch screen, display, keyboard, wired or wireless connections and/or other input or output or display components for conveying information to or from a user or another device.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure. Reference signs may be utilized in the claims to help in rendering the technical features of the claims more intelligible. These reference signs are not, however, to be construed as limiting the scope of a claim, but merely as aids to an easier understanding of the defined subject matter.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A computer-implemented method performed by a computing device for training a digital twin, the method comprising:
selecting which of one or more digital twins to train (510);
training the selected one or more digital twins with one or more transfer learning (TL) approaches (520);
determining a state of the selected one or more digital twins (530);
obtaining metadata associated with the state (540);
obtaining a subset of the one or more TL approaches based on the obtained metadata (550);
selecting one of the subsets of one or more TL approaches with a highest reward for the determined state (560);
transferring the selected TL approach to the one or more digital twins at the determined state (570); and
retraining the one or more digital twins with the selected TL approach (580).

2. The method of claim 1, wherein the training comprises obtaining a reward for each of the one or more TL approaches (840).

3. The method of claim 1, wherein the training comprises training one or more modules (235) comprising the selected one or more digital twins.

4. The method of claim 1, wherein the training is initiated by an identification of a state change (6) of the one or more digital twins.

5. The method of claim 1, wherein the training is initiated by an input (6) from one of the one or more digital twins.

6. The method of claim 4, wherein the state change is greater than a predetermined value.

7. The method of claim 4, wherein the state change is compared to a baseline state.

8. The method of claim 2, wherein the reward for each of the one or more TL approaches is received from a transfer learning (TL) proxy agent, wherein the TL proxy comprises a model for the state action space, wherein the model is trained by;
choosing one or more random actions (18);
learning an expected reward of the one or more random actions (19);
estimating an optimal action by minimizing a loss between a chosen action and an action yielding the highest reward through a loss function (20).

9. The method of claim 1, wherein the one or more TL approaches are obtained (17) from a model repository configured to store the one or more TL approaches and associate them with metadata.

10. The method of claim 4, wherein the training is initiated by a comparison (12, 13) of the one or more digital twins to one or more associated physical objects.

11-25. (canceled)

26. A computer-implemented method for configuring a network comprising a plurality of computing devices configured to train digital twins, the method comprising:
obtaining, by a computing device of the plurality of computing devices, a machine learning model (710);
determining, by the computing device, an update matrix by training the machine learning model based at least in part on a state of one or more digital twin, metadata associated with the state, one or more source domains associated with the metadata, and predetermined rewards for the one or more source domains at a plurality of states and associated metadata, wherein the update matrix comprises the one or more source domains with the highest reward for a determined state (720); and
sending, by the computing device, the update matrix to a network node for configuring the network (730).

27. The method according to claim 26, wherein the plurality of computing devices comprises a plurality of radio network nodes (1110A/B) which are configured to predict traffic load in the network using the trained machine learning model.

28. The method according to claim 26, wherein the plurality of computing devices comprises a plurality of wireless sensor devices (1112A/B) which are configured to predict operational conditions in the network using the trained machine learning model.

29. A computer-implemented method performed by a computing device for training a digital twin, the method comprising:
receiving a metadata descriptor of a digital twin, one or more source domains, and a first state of the digital twin from a network node (810);
selecting one of the one or more source domains based on the metadata descriptor, the first state, and a policy (820);
transmitting the selected source domain to the network node for use in training the digital twin (830);
receiving from the network node a first reward resulting from the training (840);
receiving from the network node a second state of the digital twin (850);
calculating a second reward of the selected source domain based at least in part on the first reward (860); and
storing the second reward, the first state, and the second state (870).

30. The method of claim 29, further comprising initializing a DQN, TQN, and experience buffer (8, 9, 10).

31. The method of claim 29 wherein the computing device comprises a TL proxy agent (210).

32. The method of claim 29, wherein the policy comprises an-greedy policy.

33. The method of claim 29, wherein the policy comprises a Markov Decision Process.

34. The method of claim 29, further comprising;
collecting a random set of one or more samples from the experience buffer for use in training a RL agent's DQN model to minimize a loss between an expected reward and an action using a predetermined discount, the one or more samples each comprising a second reward, first state and second state (30);
training the DQN model to minimize a distance between current optimal Q value and an historical Q value as captured by the TQN (31); and
updating the TQN by the DQN (32).

35-39. (canceled)
